(19) United States
(12) Patent Application Publication
(10) Pub. No.: US 2019/0022582 A1
(43) Pub. Date: Jan. 24, 2019

(54) CATALYTICALLY ACTIVE FILTER FOR USE IN HOT GAS FILTRATION, A PROCESS FOR PREPARING THE FILTER AND A METHOD FOR SIMULTANEOUS REMOVAL OF SOLID PARTICLES AND UNDESIRED CHEMICAL COMPOUNDS FROM GAS STREAMS

(71) Applicant: Haldor Topsøe A/S, Kgs Lyngby (DK)

(72) Inventor: Asad Navid, Skovlunde (DK)

(21) Appl. No.: 16/082,578

(22) PCT Filed: Apr. 5, 2017
(86) PCT No.: PCT/EP2017/058127

§ 371 Date: Sep. 6, 2018

(30) Foreign Application Priority Data
Apr. 15, 2016 (DK) PA 2016 00227

(51) Int. Cl. B01D 53/86; B01D 46/24; B01J 35/02; B01J 35/04; B01J 35/06; B01J 37/02

(52) U.S. Cl. CPC B01D 53/8606; B01D 46/2407; B01D 53/8665; B01D 53/8668; B01J 35/026; C10K 1/004; B01J 35/06; B01J 37/0225; B01J 37/0232; B01J 37/0248; B01J 37/0244; B01J 35/04

(57) ABSTRACT

A catalytically active filter for use in hot gas filtration to simultaneously remove solid particles and one or more undesirable compounds from a hot gas stream is partly or fully impregnated with a suitable catalyst. The compounds are selected from HCN, arsenic, organic sulfur compounds and carbonyls. The filter is prepared by making an impregnation liquid, which comprises a catalytically effective amount of at least one active metal and an oxide support, impregnating the filter substrate with the impregnation liquid by dipping it in the liquid or spraying it with the liquid to control the amount of liquid and drying and optionally calcining the impregnated filter.

The present invention relates to a catalytically active filter for use in hot gas filtration process and a process for preparing said filter. Further, the invention concerns a method for the simultaneous removal of solid particles and undesired chemical compounds, more specifically one or more compounds selected from hydrogen cyanide (HCN), arsenic, organic sulfur compounds and carbonyls, from gas streams, especially in gasification units such as coal, petcoke, biomass, heavy oil, refinery residue and municipal solid waste gasification plants.

Hot gas filtration (HGF) is defined as dry scrubbing of a gaseous effluent at a temperature above 260° C. (Heidenreich, Fuel 104, 83-94 (2013)). In recent years, HGF technology has been used in a large number of applications, such as incineration of industrial, chemical, animal and clinical waste, precious metal recovery, soil remediation, metal processing, waste-to-energy projects, cement and brick industries and wood and paper industries.

In a gasification plant, coal or another feed material is subjected to gasification directly with air or with O₂ obtained by passing air through an air separation unit (ASU). After gasification, the product gas is partly cleaned in a gas treating section to remove solids, either by washing in a water scrubber or by filtering (typically in a candle filter). However, some of the impurities may pass through and reach the downstream process. The most common impurities passing through a syngas treating section are arsenic, carbonyls, HCN and organic sulfur.

For chemicals and in some integrated gasification cycles combined with carbon capture (IGCC), specifically only those with CO₂ capture, the partly cleaned product gas is fed to one or more sour shift reactors, in which the reactions

CO+H₂O<->CO₂+H₂+heat (1)

COS+H₂O<->CO₂+H₂S (2)

HCN+H₂O<->NH₃+CO (3)

take place. Methane may also be formed as a by-product according to the equation

CO+3H₂<->CH₄+H₂O+heat (4)

at temperatures above 400° C. However, the formation of methane will be limited by the high steam content and/or by proper catalyst design.

In the sour shift process, catalysts comprising cobalt and molybdenum are typically employed. Such Co—Mo catalysts have the benefit of operating at moderate temperatures without requiring full sulfur removal from the feed gas to the sour shift process.

For plants without sour shift requirement, the partly cleaned syngas is fed to COS hydrolysis upstream acid gas removal (AGR), where sulfur and CO₂ are removed from the syngas by a liquid medium.

Until now, components such as HCN, arsenic, organic sulfur compounds and carbonyls have typically been removed either across the sour shift COS hydrolysis reactor or in the downstream AGR unit, both being quite cumbersome and requiring expensive processing units, and also causing plant downtime.

The present invention is based on the fact that various filter units, especially candle filters, can be made catalytically active by impregnating them with a catalyst precursor which is subsequently dried and optionally calcined. The purpose is to convert the one or more metal compounds of the catalyst precursor to their catalytically active form. In some cases, e.g. Co—Mo based catalysts, the catalyst further needs to be sulfided to be catalytically active.

According to the present invention, the filter units are impregnated with a catalyst which is active in the conversion of one or more compounds selected from HCN, organic sulfur compounds, arsenic and carbonyls.

The term “carbonyls” is to be interpreted in its broadest sense, meaning that it covers all types of carbonyl, including metal carbonyls such as Fe and/or Ni carbonyl.

Furthermore, the present invention is based on the idea that the catalyzed filter unit is placed in the syngas treating section of the process plant, so that HCN, arsenic, organic sulfur compounds and carbonyls are removed from the gas before it enters the sour shift reactor or the acid gas removal section.

A variety of methods and devices for hot gas filtration are known in the art. Thus, U.S. Pat. No. 6,863,868 discloses a hot gas filtration apparatus comprising a vessel, in which numerous filter elements are mounted. Each filter element has a porous body, on the surface of which a catalytic layer is disposed. The porous body of the filter element can be e.g. a porous ceramic monolithic matrix, a continuous fiber-reinforced ceramic composite (CFCC) matrix, a metallic matrix, an intermetallic matrix, a super alloy or a metal-ceramic composite matrix. A porous membrane for particulate removal can be positioned on one or more surfaces of the filter element. The apparatus is said to be adaptable to the various challenges of a catalytic gas phase reaction, but it is also of a quite complicated structure.

U.S. Pat. No. 9,108,134 describes a catalytic filter system comprising a filtration vessel with a fluid inlet and a fluid outlet, a separation wall inside the filtration vessel to divide the interior of the vessel into a raw gas chamber and a clean gas chamber, and a plurality of filter candles. The fluid inlet is in fluid communication with the raw gas chamber and located upstream of the plurality of filter candles, while the fluid outlet is in fluid communication with the clean gas chamber and located downstream of the plurality of filter candles. This filter system can be used e.g. for hot gas cleaning in coal gasification.

A ceramic filter element with a support material and a binder material containing a catalytic material is disclosed in US 2004/0067175. It is especially suited for removing nitrous oxides from gases.

Finally, from WO 98/03249 a gas purification device in the form of a filter candle is known. On the outside the filter candle exhibits a membrane layer of ultra-fine silicon carbide particles in order to filter out dust particles. A catalytically effective layer of sintered silicon carbide powder follows in the direction of flow inwards. As the catalytic converter, a vanadium-titanium compound is used, and the silicon carbide filter is impregnated with said compound. The filter candle is created by a subsequent coating of a porous element, which however has the disadvantage that the porous layer cannot be applied entirely uniformly in the pore area, and therefore the distribution of the catalyst material is not homogeneous. In addition to this, there is a problem with the adherence of the applied layer to the silicon carbide particles, whereby an added difficulty is that, in the area of hot gas filtration, temperature fluctuation stresses occur, which can encourage the separation of the coating.

Hot gas filtration using candle filters is a concept which has started to gain market shares in the gasification industry. Ceramic filters in the shape of filter candles are used in many industries for removal of particulate matter from process gases. They constitute one of the most efficient types of dust collectors available, and they can achieve collection efficiencies of more than 99% for particulates. The filters can be made from various ceramic materials which comprise ceramic fibres made of alkali and alkaline earth silicates or alumino silicates.

In addition to the ability of filters, such as candle filters, to remove particulate matter from process gases, the filters can also be made to have a catalytic function. Thus, the applicant has developed catalyzed ceramic candle filters and methods for the simultaneous removal of CO and NOx from flue gases or exhaust gases and also for removing VOC, CO and dioxin which are generated in many industrial processes.

The present invention relates to a catalytically active filter for use in hot gas filtration to simultaneously remove solid particles and one or more compounds selected from hydrogen cyanide (HCN), arsenic, organic sulfur compounds and carbonyls from a hot gas stream, said filter, which is partly or fully impregnated with a suitable catalyst, consists of two layers or zones, wherein the outer layer or zone, facing the gas first, is inert and serves to remove the solid particles from the gas, and the underlying layer or zone is impregnated with a catalyst-containing liquid and serves to remove one or more of said compounds from the gas.

The catalytically active filter of the invention is preferably a candle filter. However, the invention is in no way limited to candle filters.

In a candle filter, the filter substrate has the form of a hollow cylinder. The catalyst can be loaded onto the filter substrate by impregnating it with a liquid comprising the selected catalyst supported on an inorganic oxide support, e.g. by dipping the filter in the liquid or by spraying the liquid on the filter from the outer and/or the inner side of the filter. Once the liquid has been applied, the resulting filter is dried and optionally calcined. These impregnation- and drying processes can be rather challenging because, once wet, the ceramic filter substrate tends to lose most of its mechanical properties whereby it can become rather difficult to handle.

The invention further relates to a process for preparing the catalytically active filter for use in hot gas filtration, said process comprising the steps of
providing an appropriately shaped filter substrate having a gas inlet surface and a gas outlet surface,
preparing an impregnation liquid, which comprises an effective amount of one or more catalyst metal precursors which, inherently or upon activation, are capable of catalytically removing one or more compounds selected from hydrogen cyanide (HCN), arsenic, organic sulfur compounds and carbonyls,
impregnating the filter substrate with the impregnation liquid such that a defined part of the filter substrate is filled with catalyst, and
drying and optionally calcining the impregnated filter substrate.

The amount of catalyst that is loaded onto the filter has a direct impact on the catalytic performance of the resulting filter. The fact that it is possible to target the catalyst load also ensures that no excess of catalyst is loaded, whereby the overall production cost of the catalytic filter is reduced.

The liquid containing the catalyst can be applied by dipping the filter substrate in the liquid or spraying the liquid onto the filter substrate from the inner side thereof. Moreover, the amount of liquid applied is defined on the basis of the catalytic performance required. The filter can be filled with catalyst up to the point where the liquid reaches the outer surface, but it is also possible to leave the outer few millimeters of the total filter thickness in a non-impregnated state, i.e. leaving the outer surface dry. By doing so, the mechanical properties of the filter during the impregnation and drying processes are significantly enhanced due to this dry outer shell of the filter.

The terms “outer side” and “inner side” as used herein refer to the flow side of the filter facing the unfiltered gas and to the flow side facing the filtered gas, respectively.

The active materials in the catalysts used according to the invention depend on how many of the compound types selected from hydrogen cyanide (HCN), arsenic, organic sulfur compounds and carbonyls it is desired to remove. A catalyst suited to remove all compound types will typically contain both cobalt, molybdenum, nickel and active alumina. In the gasifier of the coal gasification plant, the hot (1000° C. or above) syngas goes to a waste heat recovery section, and the hot gas filter is positioned at a temperature around 300-400° C., where the particles are removed from the gas stream. Then the syngas is further conditioned in order to remove HCN, arsenic, organic sulfur compounds and carbonyls from the gas stream.

A suitable catalyst for use in the method according to the invention is Applicant's Co—Mo based SSK-10™ sour shift catalyst, which is equally suited for high temperature shift, medium temperature shift and low temperature shift applications. Typically, it contains around 3 wt % CoO and around 12 wt % MoO₃, the balance being the carrier.

The impregnated and dried filter, preferably a candle filter, is a filter where the outer surface is intact, so that it can still remove particles from the hot gas stream. A typical filter will have a diameter around 10 cm, and the inner diameter will be around 4 cm. The filter is impregnated from the center and outwards, and the dosing of the impregnation fluid is adjusted so that a defined part of the filter is filled with catalyst. As mentioned, the filter can be filled with catalyst up to the point where the liquid reaches the outer surface or to a point distant from the outer surface.

The invention also concerns a method for removal of solid particles and one or more compounds selected from hydrogen cyanide (HCN), arsenic, organic sulfur compounds and carbonyls from a gas stream, wherein the gas stream is passed through a catalytically active filter consisting of two layers or zones, of which the one facing the gas first is inert, while the other is impregnated with a catalyst-containing liquid and serves to remove one or more of said compounds from the gas.

If the gas stream is product gas from a gasification plant, the catalytically active filter is located upstream from the acid gas removal unit. Specifically, the catalytically active filter is located upstream from a sour shift reactor present in the gasification plant.

The catalytically active filter unit can also be located in the syngas treating section of the gasification plant, so that one or more compounds selected from hydrogen cyanide (HCN), arsenic, organic sulfur compounds and carbonyls is/are removed from the gas before it enters the sour shift reactor or the acid gas removal section.

1. A catalytically active filter for use in hot gas filtration to simultaneously remove solid particles and one or more compounds selected from hydrogen cyanide (HCN), arsenic, organic sulfur compounds and carbonyls from a hot gas stream, said filter, which is partly or fully impregnated with a suitable catalyst, consists of two layers or zones, wherein
the outer layer or zone, facing the gas first, is inert and serves to remove the solid particles from the gas, and
the underlying layer or zone is impregnated with a catalyst-containing liquid and serves to remove one or more of said compounds from the gas.

2. Catalytically active filter according to claim 1, wherein the catalyst comprises cobalt, molybdenum, nickel and active alumina.

3. A process for preparing a catalytically active filter for use in hot gas filtration according to claim 1, said method comprising the steps of
providing an appropriately shaped filter substrate having a gas inlet surface and a gas outlet surface,
preparing an impregnation liquid, which comprises an effective amount of one or more catalyst metal precursors which, inherently or upon activation, are capable of catalytically removing one or more compounds selected from hydrogen cyanide (HCN), arsenic, organic sulfur compounds and carbonyls,
impregnating the filter substrate with the impregnation liquid such that a defined part of the filter substrate is filled with catalyst, and
drying and optionally calcining the impregnated filter substrate.

4. Process according to claim 3, wherein the filter substrate is impregnated by spraying it with the liquid or dipping it into the liquid.

5. Process according to claim 3, wherein the filter substrate is a candle filter.

6. Process according to claim 3, wherein the filter substrate is a metal filter.

7. Process according to claim 4, wherein the filter substrate is impregnated by spraying from the hollow center to control the amount of liquid so that a defined part of the filter substrate is filled with impregnation liquid.

8. Process according to claim 7, wherein the filter is filled with impregnation liquid up to the point where the liquid reaches the outer surface.

9. Process according to claim 7, wherein the filter is filled with impregnation liquid only to a point where the outer surface is left dry.

10. Process according to claim 4, wherein the filter has an outer diameter of 10-20 cm and an inner diameter of 4-15 cm.

11. A method for removal of solid particles and one or more compounds selected from hydrogen cyanide (HCN), arsenic, organic sulfur compounds and carbonyls from a gas stream, wherein the gas stream is passed through a catalytically active filter according to claim 1.

12. Method according to claim 11, wherein the gas stream is product gas from a gasification plant, and wherein the catalytically active filter is located upstream from the acid gas removal unit.

13. (canceled)

14. Method according to claim 12, wherein the catalytically active filter is located upstream from a sour shift reactor present in the gasification plant.

15. Method according to claim 14, wherein the catalytically active filter unit is placed in the syngas treating section of the gasification plant, so that one or more compounds selected from the hydrogen cyanide (HCN), arsenic, organic sulfur compounds and carbonyls is/are removed from the gas before it enters the sour shift reactor or the acid gas removal section.
